(19) United States
(12) Patent Application Publication
(10) Pub. No.: US 2018/0175769 A1
(43) Pub. Date: Jun. 21, 2018

(54) Electrical Drive Unit

(71) Applicant: D&M HOLDING S.P.A., Vicenza (IT)

(72) Inventors: Davor Filipeti, Rasa (HR); Ezio Bertotto, Vicenza (IT); Boris Karuzic, Rasa (HR); Roberto Lotto, Vicenza (IT)

(21) Appl. No.: 15/579,758

(22) PCT Filed: May 23, 2016
(86) PCT No.: PCT/IB2016/053008

§ 371 Date: Dec. 5, 2017

(30) Foreign Application Priority Data
Jun. 12, 2015 (IT) 102015000023425

(51) Int. Cl. H02P 25/18; H02P 25/08; H02P 25/022

(52) U.S. Cl. CPC H02P 25/184; H02P 25/188; H02P 25/022; H02P 25/08

(57) ABSTRACT

An electric drive unit for driving devices connectable therewith includes at least one permanent magnets assisted reluctance motor and switching elements operatively associated to the at least one reluctance synchronous motor and designed to switch the connection of the stator windings between a first operating configuration and a second operating configuration, and vice versa, for variable torque and power delivery as a function of the rotation speed of the at least one reluctance synchronous motor.

### TECHNICAL FIELD OF THE INVENTION

The present invention relates to an electric drive unit of the kind comprising at least one stator element and at least one rotor element, the latter being of the type configured to be rotated around a rotation axis and associated to a member to be driven, in turn, in rotation.

In particular, the present invention relates to an electric drive unit comprising control means for the control and management of the drive of the electric drive unit itself.

### STATE OF THE ART

As it is known, the electric drive units of traditional type can comprise control means, such as for example an inverter, in order to control and manage the operation thereof.

The control means are configured to adjust, among the other parameters, the supply voltage of the engine, as well as the rotational speed of the same, etc.

In the transportation field, it is known the use of electric drive units, for example, integrating an endothermic unit in a vehicle or, possibly, as primary motion source for moving the vehicle itself.

In the first case, the electric drive unit allows for the reduction of the overall fuel consumption during the vehicle operation, contributing to the reduction of the pollutant emissions as well as the operating costs of the latter.

A drawback of the electric drive units of traditional type, currently used in the transportation field, regards their performances with respect to their volume and weight.

The bulk of an electric drive unit, as well as the weight thereof, can limit their use, with reference, for example, to the weight increase determined by the implementation of an electric drive unit in a vehicle. Such a weight increase can lower or even cancel the advantages indicated above.

Moreover, a further limit of the electric drive units of traditional type regards the speed range wherein their correct functioning is guaranteed.

As it is known, the maximum engine speed at which such an electric drive unit can operate depends on several elements, including the conformation of the unit itself and the components thereof, with reference, for example, to the presence or not of windings in the rotor of the electric drive unit, the presence or not and the positioning of permanent magnets in the rotor, etc.

The need is felt to provide a high performance electric drive unit, having an overall volume and weight lower than the traditional electric drive units, while ensuring better performance with respect to the latter.

In particular, such an electric drive unit must be of flexible use, with reference to the possibility of assuring a wide operation speed range.

### SUMMARY OF THE INVENTION

The aim of the present invention is that of improving the prior state of the art.

As part of such technical task, one object of the present invention is that of providing an electric drive unit able to ensure high performance with respect to electric drive units of traditional type.

Another object of the present invention is that of providing an electric drive unit able to ensure high use flexibility, with reference to the amplitude of the operation speed range within which the electric drive unit is able to correctly operate.

One further object of the present invention is that of providing an electric drive unit configured such that it can reach high rotation rates.

Another object of the present invention is that of providing an electric drive unit, the deliverable torque and power values of which can be adjusted based on the specific operation needs, as part of a solution with a reduced number of components.

According to one aspect of the present invention, an electric drive unit is foreseen according to the present application.

The present application refers to preferred and advantageous embodiments of the invention.

### BRIEF DESCRIPTION OF THE DRAWINGS

Further features and advantages of the present invention will be more evident from the detail description of one preferred, but not exclusive, embodiment, of an electric drive unit, given for indicative and not limiting purposes in the accompanying drawing tables, wherein:

FIG. 1 is a scheme of an electric drive unit according to the present invention;

FIG. 2 is a schematic chart of the torque and power characteristic curves in an electric drive unit according to the present invention;

FIG. 3 in a comparing graph between the torque characteristic curves deliverable by an electric drive unit according to the present invention, in a first and in a second configuration, respectively;

FIG. 4 in a comparing graph between the power characteristic curves deliverable by an electric drive unit according to the present invention, in a first and in a second configuration, respectively;

FIG. 5 is a scheme of a further configuration of an electric drive unit according to the present invention;

FIG. 6 is a comparing graph between the characteristic curves of the torque deliverable by the electric drive unit of FIG. 5, in a first and in a second operating configuration, respectively; and

FIG. 7 in a comparing graph between the characteristic curves of the power deliverable by the electric drive unit of FIG. 5, in a first and in a second operating configuration, respectively.

### DETAILED DESCRIPTION OF THE INVENTION

With reference to the enclosed figures, it is observed that an electric drive unit according to the present invention is overall indicated with 1.

The electric drive unit 1 comprises at least one electric motor 2, associable to control means, suitable for managing the functioning thereof as better described below.

According to one aspect of the present invention, the electric drive unit 1 is, in use, associable to supply means, not illustrated in the enclosed figures, such as for example, accumulators or a distribution network, or equivalent devices suitable for electrically supplying the electric drive unit 1 itself.

Such supply means are not the object of the present invention and, accordingly, will not be further discussed in the following.

The at least one electric motor 2 provided in the electric drive unit 1 is configured for an extremely flexible use, with reference to the rotational speed range within which it can operate, without undergoing any damage.

As said, the electric drive unit 1 according to the present invention comprises at least one electric motor 2.

Preferably, the at least one electric motor 2 is of the permanent magnet assisted synchronous reluctance type.

In the following description with the term “reluctance synchronous motor” it is intended a permanent magnet assisted reluctance synchronous motor.

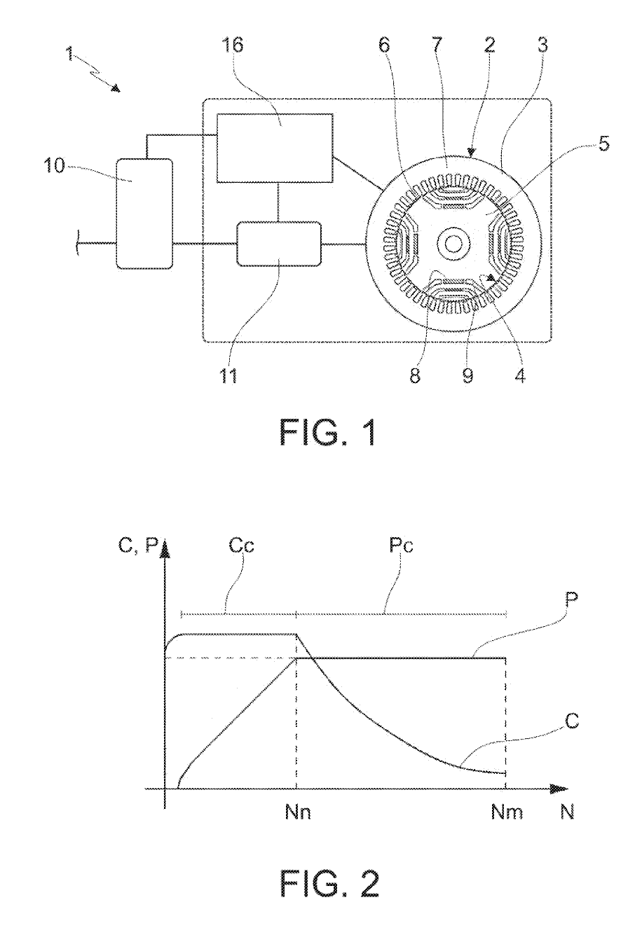

More precisely, the reluctance synchronous motor 2 is of the type having internal permanent magnets (see FIG. 1), also known as IPM (Interior Permanent Magnet).

The specific solution of the reluctance synchronous motor 2 as part of the electric drive unit 1 according to the present invention will be more clear in the following.

The working principle of a permanent magnet assisted reluctance synchronous motor 2 is considered known and, thus, the description of the features of such an electric motor will be limited to the required aspects for the understanding of the present invention.

According to one aspect of the present invention, the at least one reluctance synchronous motor 2 comprises one stator element 3 having a central seat 4 wherein one rotor 5 is placed, which rotor can be rotatably actuated with respect to the stator 3.

The rotor 5 is separated by the stator 3 by means of a space defined “air gap” 6.

Close to the internal peripheral portion of the stator 3, facing the rotor 5, a plurality of stator windings is present, globally indicated with 7.

The rotor 5 has a central symmetry axis around which it can be rotated during the functioning of the reluctance synchronous motor 2.

As said, the at least one reluctance synchronous motor 2 comprises some permanent magnets 8 placed internally with respect to the rotor 5.

To this regard, it is observed that the rotor 5 shows a plurality of shaped seats 9, within which the permanent magnets 8 are housed (see FIG. 1).

The number, position and configuration of the permanent magnets 8 and the respective seats 9 provided within the rotor element 5 can vary with respect to what shown in FIG. 1, based on specific use requirements, for example based on the number of poles of the reluctance synchronous motor 2 or specific use requirements, without exceeding for this reason the scope of protection of the present invention.

The seats 9 are parted from each other by conveying portions which define preferential paths along which the magnetic flux generated by the stator windings 7 flows.

According to one version of the present invention, the rotor 5 can be made of a plurality of sheets placed in succession against each other, reciprocally aligned to build a substantially cylindrical element.

The electric drive unit 1 can be associated, in use, to means 10 for controlling the supply parameters of the at least one reluctance synchronous motor 2 itself.

Through control means 10 it is possible to control the actuation of the electric drive unit 1 and, in particular, adjust the engine speed of the at least one reluctance synchronous motor 2.

According to one version of the present invention, the control means 10 can comprise an inverter, not shown in detail in the enclosed figures.

In FIG. 2 one graph is schematically illustrated, which shows the curve shape of the torque C and power P characteristic curves of a reluctance synchronous motor 2, as function of the speed rotation N of the motor itself.

In the graph of FIG. 2 two separate operation regions can be identified: a first region called constant torque region Cc, and a second region called constant power region Pc.

The first operation region, constant torque Cc, is comprised between a rotation speed substantially zero and a speed called nominal speed Nn for the reluctance synchronous motor 2.

The second region, constant power Pc, extends along a speed range comprised between the nominal speed Nn and the maximum speed Nm to which the reluctance synchronous motor 2 can operate without undergo damages.

In the first operation region, the reluctance synchronous motor 2 operates at a constant torque Cc regime. Within such first operation region, the magnetic flux of the rotor 5 is kept at a maximum value. Accordingly, at such working conditions, the torque C delivered by the reluctance synchronous motor 2 corresponds to the maximum torque Cc that can be produces by the same and, thus, by the electric drive unit 1 for any rotation regime of the rotor 5, comprised in the speed range above.

With the reluctance synchronous motor 2 operating in the first operation region, the power producible by the same can vary directly proportionally to the increase of the supply frequency, until it reaches a maximum value Pc at the nominal speed Nn.

For further increases in the rotation speed, the power that can be supplied by the reluctance synchronous motor 2 is substantially constant, until the reaching of the maximum speed Nm foreseen for the reluctance synchronous motor 2 itself, while a reduction of the magnetic flux linked with the rotor 5 occurs.

The reduction of the magnetic flux linked with the rotor 5 causes, in turn, a drop of the torque with respect to the maximum value Cc reached in the first operation region.

To this regard, it is observed that for speed regimes higher than the nominal one Nn, the torque of the reluctance synchronous motor 2 can decrease directly proportionally with the rotation speed value N of the rotor element 5.

Wanting to actuate the reluctance synchronous motor 2 at rotation speeds higher than the nominal speed value Nn, it is necessary to work at the so called defluxing conditions.

Through the defluxing, as it is known, it is possible to increase the rotation speed of an electric motor beyond a nominal speed value Nn, to a maximum speed value Nm that the electric motor can bear without undergoing damages.

In case of operation at speeds higher that the nominal one Nn, the reluctance synchronous motor 2 works at power and current constant conditions, while the torque is inversely proportional to the speed value N.

The defluxing, thus, can be performed in cases where high rotation speeds are required and torque values Cc lower than the maximum torque value Cc are allowable. With reference to the supply voltage, when the nominal value exceeded, i.e. the nominal rotation speed Nn is exceeded, it is not possible to further increase the voltage due to the leakage in the iron, which would increase in an unacceptable way.

Thus, as the supply frequency increases, in presence of constant voltage, a reduction of the magnetic flux linked with the stator 3 is obtained and, accordingly, a reduction of the torque C that can be supplied by the electric drive unit 1, and in particular by the reluctance synchronous motor 2 (defluxing).

According to one version of the present invention, the electric drive unit at defluxing condition can operate until a maximum rotation speed Nm equal to almost 10 times the nominal rotation speed Nn foreseen for the at least one reluctance synchronous motor 2.

The defluxing of the at least one reluctance synchronous motor 2 can be managed through control means 10 to which the electric drive unit 1 is associable.

The electric drive unit 1 comprises switching means, indicated globally with 11, designed for switching the connections of the stator windings 7 of the at least one reluctance synchronous motor 2 between a first operating configuration and a second operating configuration.

In detail, the switching means 11 are configured to allow the supply of the at least one reluctance synchronous motor 2 in a so called “star” configuration, first operating configuration, or in a so called “triangle” configuration, second operating configuration.

The star and triangle configurations, as well as their implementation, are considered known and accordingly will not be further discussed in the following.

According to one version of the present invention, the switching means 11 are provided separated from the at least one reluctance synchronous motor 2.

According to one further version of the present invention, the electric drive unit 1 comprises respective switching means 11 for each reluctance synchronous motor 2 provided in the electric drive unit 1 itself.

However, further embodiments are possible, not shown in the enclosed figures, wherein the switching means 11 can be provided inside a suitable housing provided in the stator element 3 of a reluctance synchronous motor 2, without exiting, for this reason, the scope of protection of the present invention.

By way of exemplary but not limiting example, the switching means 11 can comprise remote-control switch or similar devices commutable between the first operating configuration and the second operating configuration and vice versa.

According to a further version of the present invention, the switching means 11 can comprise electronic control devices designed for performing the above-mentioned switching between the first operating configuration and the second operating configuration and vice versa.

According to one version of the present invention, the switching means 11 can be of the remotely activatable type.

It is observed that the electric drive unit 1 comprises at least one reluctance synchronous motor 2 of the type configured to be supplied with a double nominal voltage.

As it is known, the star-triangle configurations are related with each other with a value equal to about 1.73. More precisely, in the case wherein the switching means 11 are placed in a first operating configuration, star connection, the voltage Vph on the stator windings corresponds to:

Vph_star=Vn/√3

where Vn corresponds to the nominal voltage.
The current Iph flowing through the windings corresponds to:

Iph_star=In,

where In corresponds to the nominal current.

In the case, instead, wherein the switching means 11 are placed in the second operating configuration, triangle connection, the voltage on the windings corresponds to:

Vph_triangle=Vn

The current flowing through the windings, instead, corresponds to:

Iph_triangle=In//√3

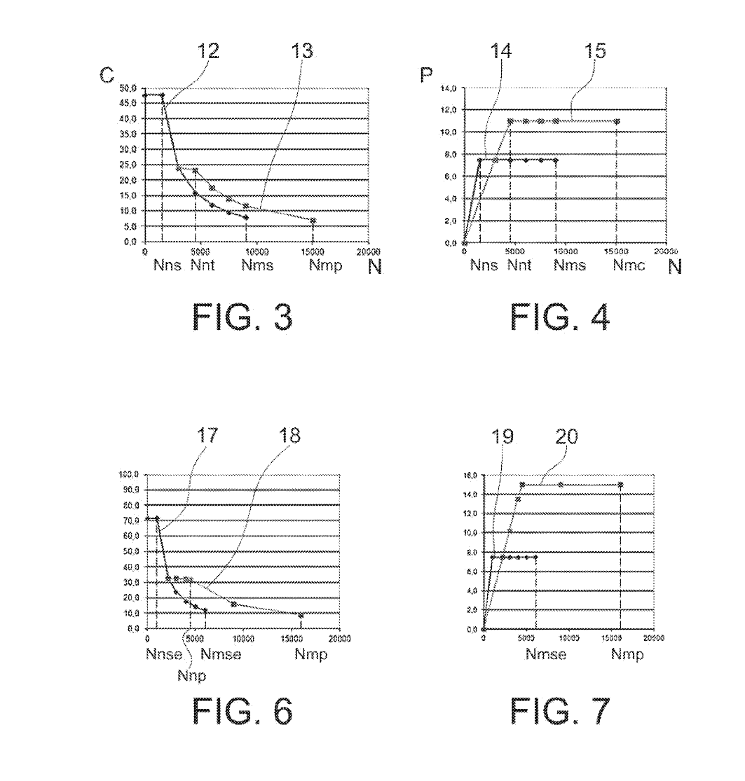

By way of an exemplary but not limiting example, in FIG. 3 a graph is shown wherein two possible torque characteristic curves 12, 13 of an electric drive unit 1 according to the present invention are illustrated.

In the graph shown in FIG. 3, in the ordinates the torque values C are indicated, while in the abscissae the rotation speed N is indicated.

The torque curve 12, hereinafter also “star curve”, corresponds to a torque curve of the electric drive unit 1 with the switching means 11 placed in the first operating configuration, of star connection of the stator element 3 phases.

The torque curve 13, hereinafter also “triangle curve”, corresponds to a torque curve of the electric drive unit 1 with the switching means 11 placed in the second operating configuration, of triangle connection of the stator element 3 phases.

Based on the characteristics of the electric drive unit 1, the torque curves 12, 13 can undergo variations with respect to what illustrated in FIG. 3, without exceeding for this reason the scope of protection of the present invention.

As a result of the switching between the first operating configuration (star) and the second operating configuration (triangle), the speed nominal value Nn of the electric drive unit 1 can vary.

In particular, the speed nominal value Nn of the electric drive unit 1 set in the second operating configuration, hereinafter triangle nominal speed Nnt, is greater than that of the nominal speed of the electric drive unit 1 set in the first operating configuration, hereinafter star nominal speed Nns.

Hence, the electric drive unit 1 in the second operating configuration (triangle) is able to supply a torque C greater than that deliverable in the first operating configuration, star torque 12, for rotation speed values greater than the triangle nominal speed Nnt.

Moreover, in the second operating configuration (triangle) the maximum value of the rotation speed Nmt is greater than the maximum speed value Nms of the first operating configuration (star).

In FIG. 4 a graph is shown wherein two possible power characteristic curves 14, 15 of an electric drive unit 1 according to the present invention are illustrated. In the graph shown in FIG. 4, in the ordinate the power values P are indicated, while in the abscissa the rotation speed N is indicated.

The curve 14, hereinafter “star power”, corresponds to a power curve of the electric drive unit 1 with the switching means 11 placed in the first operating configuration, while the curve 15, hereinafter “triangle power”, corresponds to a power curve of the electric drive unit 1 with the switching means 11 placed in the second operating configuration.

Based on the characteristics of the electric drive unit 1, the power curves 14, 15 can undergo variations with respect to what illustrated in FIG. 4, without exceeding for this reason the scope of protection of the present invention.

The electric drive unit 1 in the second operating configuration (triangle) is able to supply a power P greater than that deliverable in the first operating configuration, star power 14, for rotation speed values greater than the nominal speed of the second operating configuration, triangle speed Nnt.

According to one version of the present invention, the electric drive unit 1 comprises at least one logic unit 16 for controlling and/or driving of the switching of the switching means 11 between the first operating configuration and the second operating configuration.

By way of example, during the operation of the electric drive unit 1, in the case wherein a high torque and low rotation speed is required, the logic unit 16 determines the switching of the switching means 11 in the first operating configuration (star configuration).

In the case, instead, wherein a driving at high speed rotation is required, even if with a torque value lower than the maximum torque value deliverable by the electric drive unit 1 itself, in the first operating configuration, the logic unit 16 determines the switching of the switching means 11 from the first to the second operating configuration.

According to one version of the present invention, the logic unit 16 can be a PLC or a similar device suitable for the purpose.

According to one version of the present invention, the logic unit 16 is associable with the control means 10 in retroaction.

According to one version of the present invention, the driving of the switching means 11 can be of the manual type.

In this case, the driving of the switching means 11 between the first and the second operating configuration, and vice versa, can be performed by a user, who manually determines the switch between one of the above mentioned operating configurations.

According to such version, the logic unit 16 acts as a control of the operation of the at least one reluctance synchronous motor 2 to which it is associated.

To this regard, it is observed that the logic unit 16 is associable to control means 10, acting as a retroaction for the same.

According to a further version of the present invention, the driving of the switching means 11 occurs automatically, and it is handled by the logic unit 16. The latter, based on the required torque and on the rotation speed N of the electric drive unit 1 at which such request occurs, determines the most suitable operating configuration by driving the switching of the switching means 11 between the first or the second operating configuration.

For example, if a high torque and low rotation speed is required to the electric drive unit 1, the logic unit 16 switches the switching means 11 in the first operating configuration (star configuration).

Instead, in the case wherein a reduced torque is required with respect to the maximum value deliverable by the electric drive unit 1, with high rotation speed, the logic unit 16 switches the switching means 11 in the second operating configuration (triangle configuration).

By way of an exemplary but not limiting example, in the case wherein the electric drive unit 1 is designed for moving a vehicle, and a fully automated control exists of the switching means 11, the logic unit 16 can switch the switching means 11 in the first operating configuration if a high acceleration is required at low rotation speed. Instead, in the case wherein a reduced torque is required and lower with respect to the maximum torque values C deliverable by the electric drive unit 1, and at high speed rotation, the logic unit 16 can switch the switching means 11 in the second operating configuration.

As said, according to further versions of the present invention, the driving of the switching means 11 can occur manually.

Even in this latter case, the logic unit 16 can monitor and verify the proper functioning and use of the electric drive unit 1 itself and, in case, if a failure or heavy working conditions are detected for the at least one reluctance synchronous motor 2, it can respond for automatically driving the switching means 11 or to act, in retroaction, on the control means 10.

By way of example, in emergency or heavy conditions for the electric drive unit 1, the logic unit 16 can act on the control means 10 cutting off the supply of the at least one reluctance synchronous motor 2.

Depending on the configuration of the electric drive unit 1, the driving of the switching means 11 can therefore be operated manually and/or automatically.

In the electric drive unit 1 according to the present invention, during the switching of the switching means 11, the logic unit 16 can temporarily cut off the supply to the reluctance synchronous motor 2 in order to restore it after the switching has occurred.

With reference to the reluctance synchronous motor of traditional type, provided with permanent magnets on the external surface of the rotor element (so called SPM), it is not possible to work according to such provisions, since by cutting off the supply to the motor, the latter, being out of control, determines a voltage increase which is proportional to the rotation speed N of the synchronous motor itself.

According to one aspect of the present invention, the at least one reluctance synchronous motor 2 is configured so as to limit the effect of such a voltage increase to a maximum value, corresponding substantially to the nominal voltage of the reluctance synchronous motor 2 itself.

In particular, in the at least one reluctance synchronous motor 2, the voltage increase during the switching step, i.e. during the moments wherein the reluctance synchronous motor 2 is disconnected from the control means 10, varies proportionally to the direct contribution of permanent magnets 8.

The permanent magnets 8 are configured in such a way that during the switching step the voltage produced by the reluctance synchronous motor 2 is a fraction of the nominal voltage of the reluctance synchronous motor 2 itself.

According to one version of the present invention, the permanent magnets 8 provided in the electric drive unit 1 directly contribute for about 10%-30% to the voltage increase as a result of the rotor element 5 rotation.

In such a way, in the electric drive unit 1 it is possible to cut off the supply of the at least one reluctance synchronous motor 2 and of the control means 10 associated thereto, even at high speed rotation, without determine an excessive voltage increase which, conversely, could damage the electric drive unit 1 as well as the supply means to which the latter can be connected.

In practice, with reference to what previously described, in the electric drive unit 1 the permanent magnets 8 equipping the at least one synchronous motor 2, are designed and placed within the rotor element 5 so that, for rotation speed higher than that of the nominal speed Nn, they “generate” not more than the nominal voltage, as part of a high efficiency solution.

Thus, in the electric drive unit 1 it is possible to perform a star-triangle switch or vice versa, preventing undesired overvoltages to occur and guaranteeing, therefore, an effective operation of the electric drive unit 1.

In FIG. 5 a further embodiment of an electric drive unit the present invention is shown, globally indicates as 100.

The components of the electric drive unit 100 corresponding to those described in the previous embodiment are indicated with the same reference numerals.

The electric drive unit 100 differs from the previous embodiment only for the stator 7 windings configuration.

In the electric drive unit 100, the stator windings 7 comprise a pair of half-stator windings 7′, not shown in detail in the enclosed figures, connectable with each other according to one series or parallel configuration.

In practice, similarly to what has been described for the previous embodiment of the electric drive unit 1, the switching means 11 are configured for switching the operation of the at least one reluctance synchronous motor 2 between a first and a second operating configuration.

To this regard, it is observed that in the first operating configuration the half-stator windings 7′ are connected with each other in series.

In the second operating configuration the half-stator windings 7′ are connected with each other in parallel.

With reference to the above, the switching means 11 of the electric drive unit 100 are designed to perform a switching in the supply of the at least one reluctance synchronous motor 2 between a series and a parallel configuration and vice versa.

The series or parallel connection of the half-stator windings 7 of the reluctance synchronous motor 2 is considered known and, accordingly, will not be further described.

By way of exemplary but not limiting example, in FIG. 6 a graph is shown wherein two possible torque characteristic curves 17, 18 of an electric drive unit 100 according to the present invention are illustrated.

The torque curve 17, hereinafter also torque series, corresponds to a torque curve of the electric drive unit 100 with the switching means 11 arranged in the first operating configuration, wherein the half-stator windings 7′ are connected with each other in series.

The torque curve 18, hereinafter also parallel torque, corresponds to a torque curve of the electric drive unit 100, with the switching means 11 placed in the second operating configuration, wherein the half-stator windings 7′ are connected with each other in parallel.

Similarly to what is described for the previous embodiment, the nominal speed of the electric drive unit 100 arranged in the second operating configuration (parallel), parallel nominal speed Nnp, is greater than that of the electric drive unit 100 arranged in the first operating configuration (series), hereinafter series nominal speed Nnse.

Moreover, in the second operating configuration (parallel) the maximum value of the rotation speed Nmp is greater than the maximum speed value Nmse of the first operating configuration (series).

According to the characteristics of the electric drive unit 1, the torque curves 17, 18 can undergo variations with respect to what illustrated in FIG. 5, without exceeding for this reason the scope of protection of the present invention.

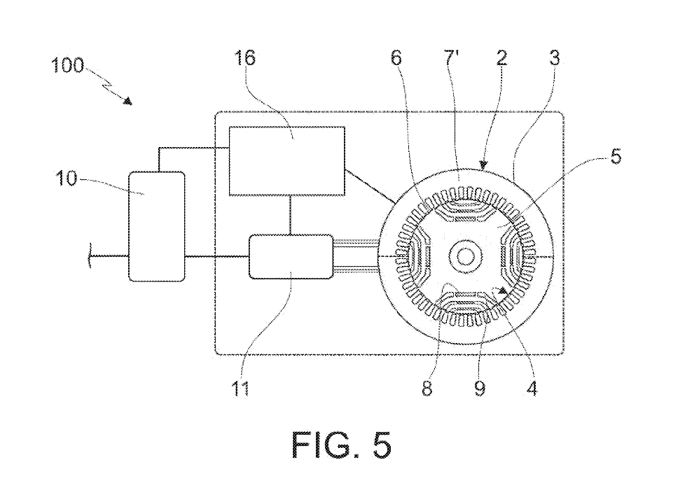

Similarly to what is described above, in FIG. 7 a graph is shown wherein two possible power characteristic curves 19, 20 of an electric drive unit 100 according to the present invention are illustrated.

The power curve 19, hereinafter series power, corresponds to a power curve of the electric drive unit 100, with the switching means 11 in the first operating configuration, while the power curve 20, hereinafter parallel power, corresponds to a power curve of the electric drive unit 100, with the switching means 11 arranged according to the second operating configuration.

Based on the characteristics of the electric drive unit 100, the power curves 19, 20 can undergo some variations with respect to what illustrated in FIG. 7, without exceeding for this reason the scope of protection of the present invention.

With regards to the first operating configuration and the second operating configuration of the electric drive unit 100, reference is made to what described above in relation to the previous embodiment.

The electric drive unit 100 allows obtaining the same advantages described above for the previous embodiment.

The electric drive unit 1, 100 according to the present invention allows obtaining an electrical driving of extremely flexible use, since the latter can work under constant torque or power conditions within a wider speed range with respect to the electric drive units of traditional type.

Moreover, the weight and dimensions of an electric drive unit 1, 100 according to the present invention are lower with respect to drive units of traditional type having comparable performances.

In view of the features above, the electric drive unit 1, 100 can be employed in different fields.

By way of example, the electric drive unit 1, 100 can be used as a source for vehicle traction.

For example, the electric drive unit 1, 100 can be used as support of an endothermic unit or, in case, as unique motion source for a vehicle movement.

As said, the electric drive unit 1, 100 can present, for equal performances, a reduced weight and overall dimensions with respect to the electric drive unit of traditional type.

The overall dimensions reduction can promote the implementation of the electric drive unit 1, 100 within a vehicle.

Moreover, the weight reduction of the electric drive unit 1, 100 can promote the choice thereof with respect to the solutions of traditional type which, for equal performances, are heavier.

Given the high use flexibility of the electric drive unit 1, 100 the same can be used even in fields different with respect to that indicated above with reference, for example, to applications like pumps, fans or driving of weaving devices, machines in general, etc.

The invention thereby conceived is susceptible of numerous modifications and variations all falling within the inventive concept.

Moreover, all the details can be replaced by other technically equivalent elements. In practice, the employed materials, as well as the contingent configurations and dimensions may be any according to the needs without exiting for this reason the scope of protection of the following claims.

1. An electric drive unit, associable to power supply means for the actuation of devices connectable to said electric drive unit, comprising at least one reluctance motor assisted by permanent magnets comprising a stator provided with stator windings and a central seat for housing a rotor rotatably associated to said stator, said electric drive unit further comprising switching means operatively associated with said at least one synchronous reluctance motor assisted by permanent magnets, said switching means being configured for switching the connection of said stator windings of said synchronous reluctance motor assisted by permanent magnets between a first operating configuration and a second operating configuration, and vice versa, for variable torque and power supply as a function of the rotation speed of said rotor.

2. The electric drive unit according to claim 1, wherein said at least one synchronous reluctance motor assisted by permanent magnets comprises permanent magnets housed inside respective seats provided inside said rotor.

3. The electric drive unit according to claim 1, wherein said permanent magnets are arranged within said seats in such a way as to determine a direct contribution to the voltage of the at least one synchronous reluctance motor assisted by permanent magnets comprised between 10% and 30% of the rated voltage of said at least one synchronous reluctance motor assisted by permanent magnets.

4. The electric drive unit according to claim 1, comprising at least one logic unit for controlling the switching of said switching means and driving said at least one synchronous reluctance motor assisted by permanent magnets.

5. The electric drive unit according to claim 4, wherein said logic unit is operatively connected to said switching means, for controlling and switching of said switching means between said first operating configuration and said second operating condition, and vice versa.

6. The electric drive unit according to claim 5, wherein said at least one logic unit is a PLC.

7. The electric drive unit according to claim 1, wherein said switching means are manually operable.

8. The electric drive unit according to claim 1, wherein said switching means are automatically operated contactors.

9. The electric drive unit according to claim 1, wherein said switching means are configured for switching the connection of said stator windings of said at least one synchronous reluctance motor assisted by permanent magnets between said first operating configuration, wherein said stator windings are connected in star, and said second operating configuration, wherein said stator windings are connected in delta, and vice versa.

10. The electric drive unit according to claim 1, wherein said stator comprises a pair of half-stator windings.

11. The electric drive unit according to claim 10, wherein said switching means are configured for switching the connection of said half-stator windings between said first operating configuration, wherein said half-stator windings are connected in series, and said second operating configuration, wherein said half-stator windings are connected in parallel, and vice versa.
